(19) United States
(12) Patent Application Publication
(10) Pub. No.: US 2020/0007948 A1
(43) Pub. Date: Jan. 2, 2020

(54) VIDEO SUBTITLE DISPLAY METHOD AND APPARATUS

(71) Applicant: Alibaba Group Holding Limited, Grand Cayman (KY)

(72) Inventors: Min Li, Hangzhou (CN); Lei Zhang, Beijing (CN)

(73) Assignee: Alibaba Group Holding Limited

(21) Appl. No.: 16/452,433

(22) Filed: Jun. 25, 2019

(30) Foreign Application Priority Data
Jun. 29, 2018 (CN) 201810700335.2

(51) Int. Cl. H04N 21/488; H04N 5/445; H04N 7/088

(52) U.S. Cl. CPC H04N 21/4884; H04N 5/44504; H04N 2005/44526; H04N 7/0885; H04N 5/44513

(57) ABSTRACT

A video subtitle display method and apparatus, the method including: determining, upon receiving a play request with regard to a target video, identification information indicated by the play request; evaluating whether a first subtitle display mode corresponding to the identification information exists; and displaying subtitles of a target video on a video picture of the target video during a process of playing the target video, based on a first subtitle display mode determined to exist corresponding to the identification information. Video subtitle display methods and apparatuses provided by example embodiments of the present disclosure enable a video subtitle display mode may change based on differences between first subtitle display modes corresponding to different identification information, satisfying viewing needs of different users for subtitles in video pictures.

### CROSS REFERENCE TO RELATED PATENT APPLICATIONS

This application claims priority to Chinese Patent Application No. 201810700335.2, filed on Jun. 29, 2018 and entitled “VIDEO SUBTITLE DISPLAY METHOD AND APPARATUS”, which is hereby incorporated by reference in its entirety.

### TECHNICAL FIELD

The present disclosure relates to the field of computers, and particularly relates to video subtitle display methods and apparatuses.

### BACKGROUND

As technology constantly advances, a user may view liked videos through a mobile phone and such terminals, in conjunction with subtitles to understanding the particular contents of the videos. However, in related technology, during a process of playing a video, a display mode of subtitles is fixed and singular, which cannot satisfy viewing needs of different users for subtitles in videos.

### SUMMARY

This summary is provided to introduce a selection of concepts in a simplified form that are further described below in the Detailed Description. This Summary is not intended to identify all key features or essential features of the claimed subject matter, nor is it intended to be used alone as an aid in determining the scope of the claimed subject matter. The term “technique(s) or technical solution(s)” for instance, may refer to apparatus(s), system(s), method(s) and/or computer-readable instructions as permitted by the context above and throughout the present disclosure.

In view of this, the present disclosure sets forth a video subtitle display method and apparatus.

According to an aspect of the present disclosure, a video subtitle display method is provided, the method including:

Determining, upon receiving a play request with regard to a target video, identification information indicated by the play request;

Evaluating whether a first subtitle display mode corresponding to the identification information exists; and

Displaying subtitles of a target video on a video picture of the target video during a process of playing the target video, based on a first subtitle display mode determined to exist corresponding to the identification information.

With regard to the above-mentioned method, according to a possible implementation, the method further includes:

Showing, based on a detected trigger operation performing adjustment upon a subtitle display mode, a mode adjustment interface operative to adjust a subtitle display mode;

Performing, based on a detected adjustment operation with regard to the mode adjustment interface, display adjustment upon the first subtitle display mode, and determining an adjusted first subtitle display mode; and

Determining an adjusted first subtitle display mode as a first subtitle display mode corresponding to the identification information;

Wherein display adjustment includes at least one of display position adjustment, display typeface adjustment, display color adjustment, display size adjustment, arrangement adjustment, display background adjustment and display background transparency adjustment.

With regard to the above-mentioned method, according to a possible implementation, the method further includes:

Showing, upon detecting a trigger operation performing selection among subtitle display modes, multiple second subtitle display modes pending selection;

Determining, based on a detected selection operation with regard to multiple second subtitle display modes, a selected second subtitle display mode; and

Determining the selected second subtitle display mode as a first subtitle display mode corresponding to identification information.

With regard to the above-mentioned method, according to a possible implementation, creating, based on a detected creation operation with regard to the creation interface, a third subtitle display mode includes:

Performing, upon detecting a first creation operation with regard to the creation interface, text typeface analysis upon detected input content, and determining a display typeface of subtitles of the third subtitle display mode based on analysis results;

Wherein input content includes one of text and an image containing text.

With regard to the above-mentioned method, according to a possible implementation, creating, based on a detected creation operation with regard to the creation interface, a third subtitle display mode includes:

Processing, upon detecting a second creation operation with regard to the creation interface, a detected input image, determining a display background of subtitles of the third subtitle display mode.

With regard to the above-mentioned method, according to a possible implementation, first subtitle display modes corresponding to the identification information are multiple first subtitle display modes, and;

Herein, displaying subtitles of a target video on a video picture of the target video during a process of playing the target video, based on a first subtitle display mode determined to exist corresponding to the identification information, includes:

Showing multiple first subtitle display modes;

Determining, based on detecting a selection operation with regard to the multiple first subtitle display modes, a selected first subtitle display mode; and

Displaying, during a process of playing a target video, based on a selected first subtitle display mode, subtitles of the target video in a video picture of the target video.

With regard to the above-mentioned method, according to a possible implementation, the method further includes:

Determining, when a first subtitle display mode corresponding to the identification information does not exist, historical data of a subject identified by the identification information; and

Determining, based on historical data, a first subtitle display mode corresponding to the identification information;

Wherein the historical data includes at least one of: historical behavior data of the subject, and user profile data of the subject.

With regard to the above-mentioned method, according to a possible implementation, a subject identified by identification information includes at least one of a terminal, a client terminal loaded by a terminal, and an account logged in through a terminal; and

Identification information includes at least one of an IP address of a terminal, an identifier of an account logged in through a terminal, an identifier of a client terminal loaded by a terminal, an identifier of an account logged in through a client terminal, and an identifier of a terminal.

With regard to the above-mentioned method, according to a possible implementation, a first subtitle display mode includes at least one of:

A display position, a display typeface, a display color, a display size, an arrangement, a display background, and a transparency of a display background of subtitles on the video picture.

According to an aspect of the present disclosure, a video subtitle display apparatus is provided, the apparatus including:

A request receiving module configured to determine, upon receiving a play request with regard to a target video, identification information indicated by the play request;

A display evaluating module configured to evaluate whether a first subtitle display mode corresponding to the identification information exists; and

A play controlling module configured to display subtitles of a target video on a video picture of the target video during a process of playing the target video, based on a first subtitle display mode determined to exist corresponding to the identification information.

With regard to the above-mentioned apparatus, according to a possible implementation, the apparatus further includes:

A mode adjustment interface showing module configured to show, based on a detected trigger operation performing adjustment upon a subtitle display mode, a mode adjustment interface operative to adjust a subtitle display mode;

A display adjustment module configured to perform, based on a detected adjustment operation with regard to the mode adjustment interface, display adjustment upon the first subtitle display mode, and determine an adjusted first subtitle display mode; and

A first mode adjusting module configured to determine an adjusted first subtitle display mode as a first subtitle display mode corresponding to the identification information;

Wherein display adjustment includes at least one of display position adjustment, display typeface adjustment, display color adjustment, display size adjustment, arrangement adjustment, display background adjustment and display background transparency adjustment.

With regard to the above-mentioned apparatus, according to a possible implementation, the apparatus further includes:

A mode showing module configured to show, upon detecting a trigger operation performing selection among subtitle display modes, multiple second subtitle display modes pending selection;

A mode selecting mode configured to determine, based on a detected selection operation with regard to multiple second subtitle display modes, a selected second subtitle display mode; and

A second mode determining module configured to determine the selected second subtitle display mode as a first subtitle display mode corresponding to identification information.

With regard to the above-mentioned apparatus, according to a possible implementation, the apparatus further includes:

A creation interface showing module configured to show, upon detecting a trigger operation creating a third subtitle display mode, a creation interface operative to perform subtitle display mode creation;

A mode creating module configured to create, based on a detected creation operation with regard to the creation interface, a third subtitle display mode; and

A third mode determining module configured to determine the third subtitle display mode as a first subtitle display mode corresponding to identification information.

With regard to the above-mentioned apparatus, according to a possible implementation, the mode creating module further includes:

A first creating submodule configured to perform, upon detecting a first creation operation with regard to the creation interface, text typeface analysis upon detected input content, and determine a display typeface of subtitles of the third subtitle display mode based on analysis results;

Wherein input content includes one of: text, and an image containing text.

With regard to the above-mentioned apparatus, according to a possible implementation, the mode creating module further includes:

A second creating submodule configured to process, upon detecting a second creation operation with regard to the creation interface, a detected input image, determining a display background of subtitles of the third subtitle display mode.

With regard to the above-mentioned apparatus, according to a possible implementation, first subtitle display modes corresponding to the identification information are multiple first subtitle display modes, and

Wherein the play controlling module includes:
A showing submodule configured to show multiple first subtitle display modes;
A selection determining submodule configured to determine, based on detecting a selection operation with regard to the multiple first subtitle display modes, a selected first subtitle display mode; and
A play controlling submodule configured to display, during a process of playing a target video, based on a selected first subtitle display mode, subtitles of the target video in a video picture of the target video.

With regard to the above-mentioned apparatus, according to a possible implementation, the apparatus further includes:

A historical data determining module configured to determine, when a first subtitle display mode corresponding to the identification information does not exist, historical data of a subject identified by the identification information; and

A fourth mode determining module configured to determine, based on historical data, a first subtitle display mode corresponding to the identification information;

Wherein the historical data includes at least one of: historical behavior data of the subject, and user profile data of the subject.

With regard to the above-mentioned apparatus, according to a possible implementation, a subject identified by identification information includes at least one of: a terminal, a client terminal loaded by a terminal, and an account logged in through a terminal; and

Identification information includes at least one of: an IP address of a terminal, an identifier of an account logged in through a terminal, an identifier of a client terminal loaded by a terminal, an identifier of an account logged in through a client terminal, and an identifier of a terminal.

With regard to the above-mentioned apparatus, according to a possible implementation, the first subtitle display mode includes at least one of the following:

A display position, a display typeface, a display color, a display size, an arrangement, a display background, and a transparency of a display background of subtitles on the video picture.

According to an aspect of the present disclosure, a video subtitle display apparatus is provided, including: a processor; and memory utilized to store instructions executable by the processor; wherein the processor is configured to execute the above-mentioned methods.

According to an aspect of the present disclosure, a non-volatile computer-readable storage medium is provided, wherein computer program instructions are stored thereon, the computer program instructions being executable by a processor to implement the above-mentioned methods.

The present disclosure presents a video subtitle display method and apparatus, determining, upon receiving a play request with regard to a target video, identification information indicated by the play request; evaluating whether a first subtitle display mode corresponding to the identification information exists; and displaying subtitles of a target video on a video picture of the target video during a process of playing the target video, based on a first subtitle display mode determined to exist corresponding to the identification information. A video subtitle display mode may change based on differences between first subtitle display modes corresponding to different identification information, satisfying viewing needs of different users for subtitles in video pictures.

Based on the detailed description of the exemplary embodiments below with reference to the drawings, other features and aspects of the present disclosure shall become clear.

### BRIEF DESCRIPTION OF THE DRAWINGS

The drawings, being contained in the specification and forming a part of the specification, demonstrate, together with the specification, exemplary embodiments, features and aspects of the present disclosure, and are utilized to explain principles of the present disclosure.

FIG. 1 illustrates a flowchart of a video subtitle display method according to an example embodiment of the present disclosure.

FIG. 2 illustrates a flowchart of a video subtitle display method according to an example embodiment of the present disclosure.

FIG. 3 illustrates a flowchart of a video subtitle display method according to an example embodiment of the present disclosure.

FIG. 4 illustrates a flowchart of a video subtitle display method according to an example embodiment of the present disclosure.

FIG. 5 illustrates a flowchart of a video subtitle display method according to an example embodiment of the present disclosure.

FIG. 6 illustrates a flowchart of a video subtitle display method according to an example embodiment of the present disclosure.

FIG. 7 illustrates a flowchart of step 106 of a video subtitle display method according to an example embodiment of the present disclosure.

FIG. 8 illustrates a flowchart of a video subtitle display method according to an example embodiment of the present disclosure.

FIG. 9 illustrates a block diagram of a video subtitle display apparatus according to an example embodiment of the present disclosure.

FIG. 10 illustrates a block diagram of a video subtitle display apparatus according to an example embodiment of the present disclosure.

FIG. 11 illustrates a block diagram of a video subtitle display apparatus according to an example embodiment of the present disclosure.

FIG. 12 illustrates a block diagram of a video subtitle display apparatus according to an example embodiment of the present disclosure.

### DETAILED DESCRIPTION

The below, in reference to the drawings, describes various exemplary embodiments, features and aspects of the present disclosure in detail. The same figure reference symbols of the drawings signify elements having the same or similar functions. Although various aspects of the example embodiments are shown in the drawings, unless expressly indicated, the drawings are not necessarily to scale.

The word “exemplary” as used exclusively herein means “used for example, embodiment or illustrative purposes.” Any embodiment described herein as “exemplary” shall not be interpreted as being superior to or better than other embodiments.

Additionally, for better description of the present disclosure, many particular details are given in particular implementations of the below text. Persons skilled in the art shall grasp that the present disclosure may be implemented without certain details. In some embodiments, methods, techniques, elements and circuits well-known to persons skilled in the art shall not be described in detail, to facilitate highlighting the subject matter of the present disclosure.

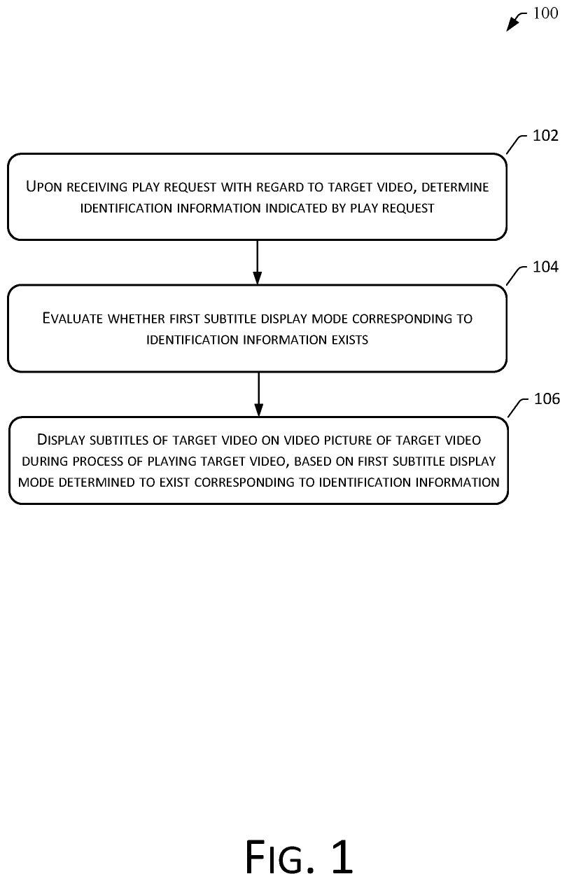

FIG. 1 illustrates a flowchart of a video subtitle display method 100 according to an example embodiment of the present disclosure. The method 100 may be applied to a mobile phone, a computer and such terminals, and may also be applied to a server. As shown by FIG. 1, the method 100 includes step 102 to step 106.

In step 102, upon receiving a play request with regard to a target video, identification information indicated by the play request is determined.

According to a possible implementation, a subject identified by identification information may include at least one of a terminal, a client terminal loaded by a terminal, and an account logged in through a terminal. Identification information may include at least one of an IP address of a terminal, an identifier of an account logged in through a terminal, an identifier of a client terminal loaded by a terminal, an identifier of an account logged in through a client terminal, and an identifier of a terminal.

Herein, an IP address of a terminal refers to an Internet Protocol Address of a terminal. An identifier of an account logged in through a terminal may refer to a login account by which a user logs into the terminal and such identifiers; for example, a login account by which a certain user logs into a mobile phone of the user. An identifier of a client terminal loaded by a terminal may be an identifier of a client terminal running on the terminal; for example, an identifier of a client terminal of a certain video website on a server. An identifier of an account logged in through a client terminal may be a user account, nickname, mobile phone number, email address, and such identifier by which a user logs into the client terminal. An identifier of a terminal may be a model of the terminal and such identifier information related to the terminal. Persons skilled in the art may, based on actual needs, configure identification information and subjects identified by identification information, which shall not be limited by the present disclosure.

In step 104, whether a first subtitle display mode corresponding to the identification information exists is evaluated.

According to the present example embodiment, a first subtitle display mode and a second subtitle display mode and third subtitle display mode as described by the below text may all be display states of subtitles of a target video on a certain video picture during the process of playing the target video.

In step 106, subtitles of a target video are displayed on a video picture of the target video during a process of playing the target video, based on a first subtitle display mode determined to exist corresponding to the identification information.

According to the present example embodiment, one, or more than one, first subtitle display mode(s) corresponding to the identification information may exist, and the present disclosure shall not be limiting thereto. Upon determining that the number of first subtitle display modes is one, during a process of playing a target video for a user, based on the first subtitle display mode, subtitles of the target video may be displayed on a video picture of the target video. Upon determining that the number of first subtitle display modes is more than one, based on a selection by a user, a selected first subtitle display mode may be determined. Then, during a process of playing a target video, based on the selected first subtitle display mode, subtitles of the target video may be displayed on a video picture of the target video.

According to a possible implementation, a first subtitle display mode may include at least one of the following: a display position, a display typeface, a display color, a display size, an arrangement, a display background, and a transparency of a display background of subtitles on the video picture.

Herein, a display position of subtitles may be an upper side, a lower side, a left side, or a right side of a video picture, and such arbitrary positions in a picture. A display typeface of subtitles may be, for example, songti or kaiti in the case of Chinese characters, or serif or sans-serif in the case of Latin characters, or any arbitrary typeface, and may be a customized typeface determined based on user input; for example, a display typeface may be a typeface employed by a user's own written text. A display color of subtitles may be black, white and such single colors, or may be colored to include multiple colors. Multiple characters of subtitles may have a same display color, or may have different display colors. A display size of subtitles may be 4 points, 3 points and such arbitrary sizes. An arrangement of subtitles may include a horizontal arrangement (text reading direction may be left-to-right, or may be right-to-left) and a vertical arrangement (text reading direction may be top-to-bottom, or may be bottom-to-top). A display background of subtitles may be a solid color background, such as a white background or a black background. A display background of subtitles may also be a background having particular colors and patterns, such as a background having a blue cloud pattern. A display background of subtitles may also be a customized background determined based on a user-input image, such as a photo shot by the user. A transparency of a display background of subtitles may be 100%, 50%, and the like. The lower a transparency of a display background, the clearer the text in subtitles viewed by a user; the higher a transparency of a display background, the less that the subtitles obscure the video picture, and the better the outcome of viewing the video picture.

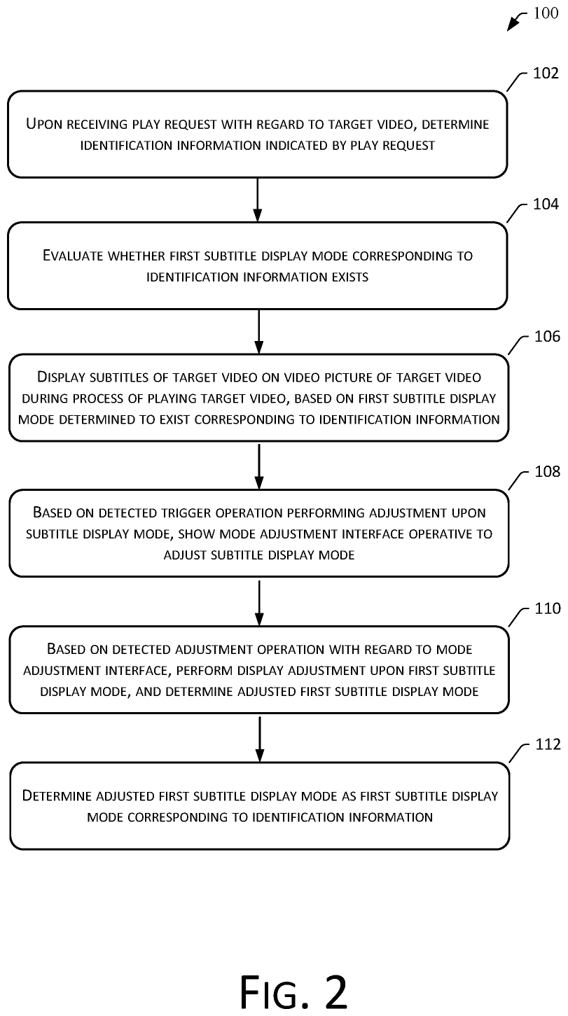

FIG. 2 illustrates a flowchart of a video subtitle display method 100 according to an example embodiment of the present disclosure. In a possible implementation, as shown by FIG. 2, the method 100 may also include step 108 to step 112.

In step 108, based on a detected trigger operation performing adjustment upon a subtitle display mode, a mode adjustment interface operative to adjust a subtitle display mode is shown.

According to the present implementation, a first control operative to perform adjustment upon a subtitle display mode may be configured; upon detecting a click, a double click and such trigger operations upon the first control, a mode adjustment interface operative to adjust a subtitle display mode is shown for a user. A mode adjustment interface may be shown for a user by a popup, a window, and such forms. For example, upon a user performing a click operation upon a first control with regard to a subtitle display mode through a mobile phone, on a new popup in a currently displayed interface of the mobile phone, a mode adjustment interface is shown for the user.

According to the present implementation, adjustment controls available for user operation and a subtitle display diagram of a current first subtitle display mode may be shown in the mode adjustment interface. This facilitates a user performing operations upon adjustment controls, adjusting subtitle display modes, and determining a display mode of subtitles on a video picture based on the subtitle display diagram of the first subtitle display mode.

In step 110, based on a detected adjustment operation with regard to the mode adjustment interface, display adjustment is performed upon the first subtitle display mode, and an adjusted first subtitle display mode is determined. Herein, display adjustment may include at least one of display position adjustment, display typeface adjustment, display color adjustment, display size adjustment, arrangement adjustment, display background adjustment and display background transparency adjustment.

According to the present example embodiment, based on display adjustment configuration and a corresponding adjustment control, and based on a detected operation with regard to the adjustment control, display adjustment may be performed upon the first subtitle display mode. Persons skilled in the art may configure up implementations of display adjustment based on actual needs, and the present disclosure shall not be limiting thereto.

In step 112, an adjusted first subtitle display mode is determined as a first subtitle display mode corresponding to the identification information.

According to the present example embodiment, after determining an adjusted first subtitle display mode, based on the identification information, an adjusted first subtitle display mode may be determined as a first subtitle display mode corresponding to the identification information, facilitating, during a subsequent process of playing video for a user, based on the first subtitle display mode corresponding to the identification information, displaying subtitles of the video for the user.

According to the present example embodiment, a user may, before the target video is played, perform display adjustment upon the first subtitle display mode, and may, during the playback procedure of the target video, perform display adjustment upon the first subtitle display mode. The present disclosure shall not be limiting thereto.

In the above-mentioned manner, a user may perform display adjustment upon a first subtitle display mode, causing subtitles displayed in a video picture to satisfy the user's own viewing needs.

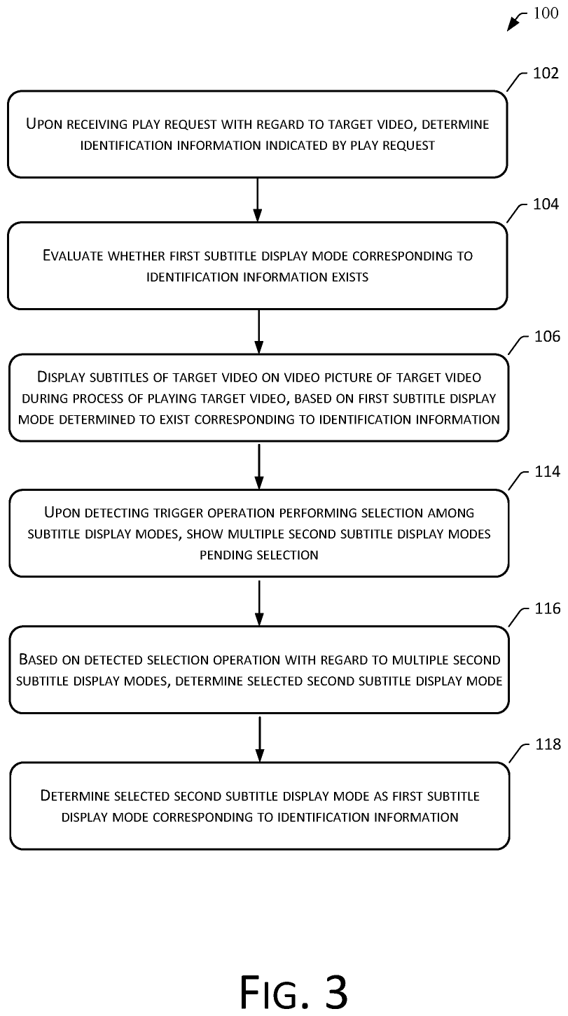

FIG. 3 illustrates a flowchart of a video subtitle display method 100 according to an example embodiment of the present disclosure. In a possible implementation, as shown by FIG. 3, the method 100 may also include step 114 to step 118.

In step 114, upon detecting a trigger operation performing selection among subtitle display modes, multiple second subtitle display modes pending selection are shown.

According to the present implementation, a second control utilized to select subtitle display modes may be shown for a user, and upon detecting a click, a double click and such trigger operations upon the second control, multiple second subtitle display modes pending selection may be shown for the user through a window, a popup, and the like. Furthermore, upon detecting a finger or mouse cursor of a user pointing at any second subtitle display mode, a corresponding subtitle display diagram may be displayed at a position of the second subtitle display mode, facilitating the user, in conjunction with the subtitle display diagram, determining a particular display mode of the second subtitle display mode.

In step 116, based on a detected selection operation with regard to multiple second subtitle display modes, a selected second subtitle display mode is determined.

According to the present implementation, upon detecting a click, a double click and such operations with regard to a second subtitle display mode, a detected selection operation with regard to multiple second subtitle display modes may be determined, and a selected second subtitle display mode may be determined.

In step 118, the selected second subtitle display mode is determined as a first subtitle display mode corresponding to identification information.

According to the present implementation, after determining the selected second subtitle display mode, based on identification information, the selected subtitle display mode may be determined as a first subtitle display mode corresponding to the identification information, facilitating, during a subsequent process of playing video for a user, based on the first subtitle display mode corresponding to the identification information, displaying subtitles of the video for the user.

According to the present implementation, a user may, before the target video is played, perform selection among multiple second subtitle display modes, and may, during the playback procedure of the target video, perform selection among multiple second subtitle display modes. The present disclosure shall not be limiting thereto.

In the above-mentioned manner, a user may perform selection among second subtitle display modes, and, based on a selection of the user, a selected second subtitle display mode may be determined as a first subtitle display mode corresponding to identification information, causing subtitles displayed in a video picture to satisfy the user's own viewing needs.

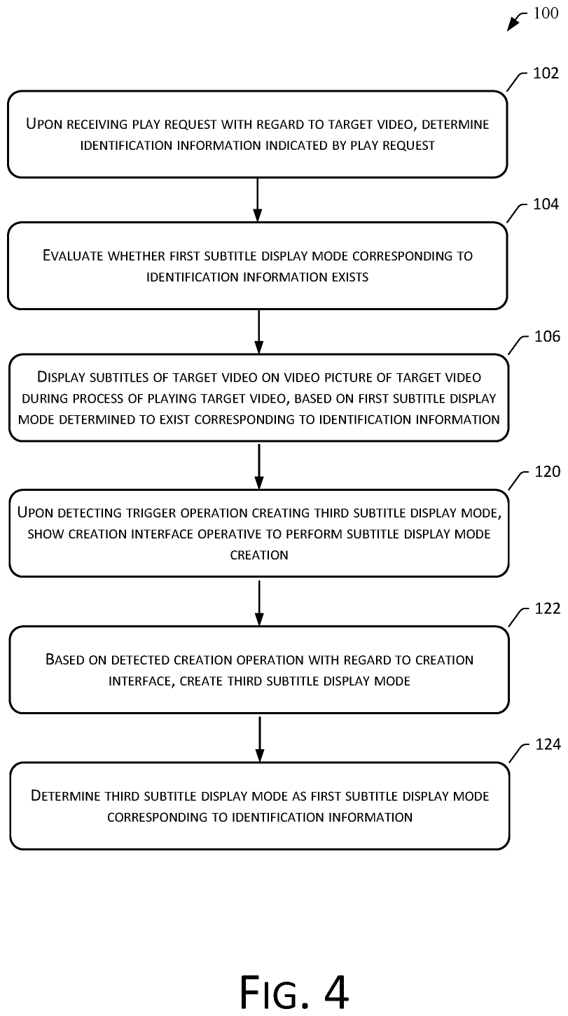

FIG. 4 illustrates a flowchart of a video subtitle display method 100 according to an example embodiment of the present disclosure. In a possible implementation, as shown by FIG. 4, the method 100 may also include step 120 to step 124.

In step 120, upon detecting a trigger operation creating a third subtitle display mode, a creation interface operative to perform subtitle display mode creation is shown.

According to the present implementation, a third control operative to create a third subtitle display mode may be shown for a user; upon detecting a click, a double click and such trigger operations upon the third control, a creation interface operative to perform subtitle display mode creation is shown for a user by a window, a popup, and such manners.

In step 122, based on a detected creation operation with regard to the creation interface, a third subtitle display mode is created.

According to the present example embodiment, a creation control operative to create subtitle display modes and a subtitle display diagram corresponding to a third subtitle display mode may be displayed in the creation interface, and based on a detected operation upon the creation control, a third subtitle display mode may be created. This way, at the same time as creating the third subtitle display mode, a subtitle display diagram may be displayed for a user, enabling the user to, based on the subtitle display diagram, determine a particular display mode of subtitles of the third subtitle display mode in a video picture, facilitating the subsequent creation of the third subtitle display mode.

In step 124, the third subtitle display mode is determined as a first subtitle display mode corresponding to identification information.

According to the present example embodiment, after creating a third subtitle display mode, identification information is obtained, and then the third subtitle display mode may be determined as a first subtitle display mode corresponding to the identification information, facilitating, during a subsequent process of playing video for a user, based on the first subtitle display mode corresponding to the identification information, displaying subtitles of the video for the user.

According to the present example embodiment, a user may, before the target video is played, create the third subtitle display mode, and may, during the playback procedure of the target video, create the third subtitle display mode. The present disclosure shall not be limiting thereto.

In the above-mentioned manner, a user may personally create a third subtitle display mode, causing subtitles displayed in a video picture to satisfy the user's specific needs, enabling display modes of subtitles to be more diverse, and enhancing appeal of subtitle display.

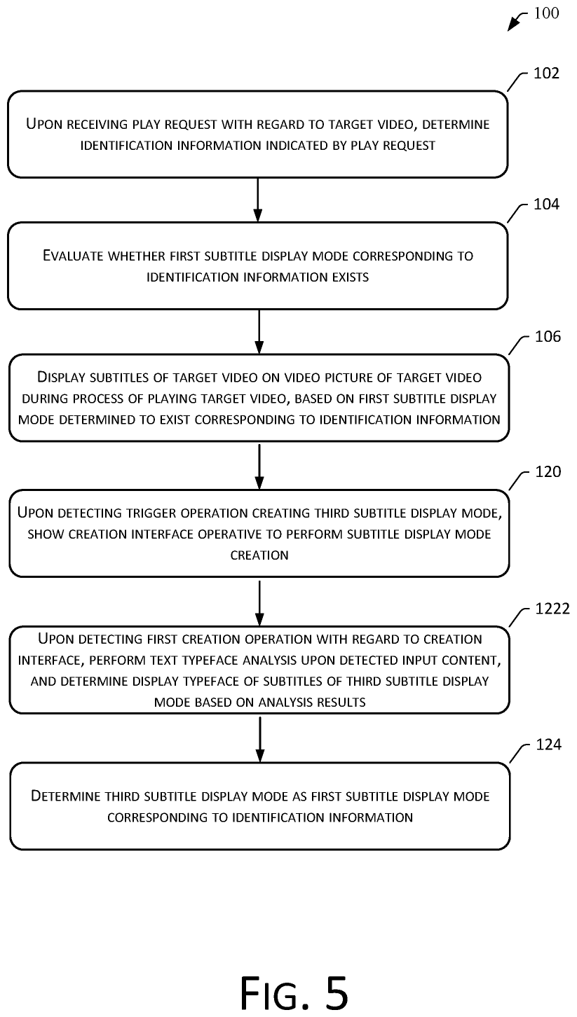

FIG. 5 illustrates a flowchart of a video subtitle display method 100 according to an example embodiment of the present disclosure. In a possible implementation, as shown by FIG. 5, step 122 may include step 1222.

In step 1222, upon detecting a first creation operation with regard to the creation interface, text typeface analysis is performed upon detected input content, and a display typeface of subtitles of the third subtitle display mode is determined based on analysis results.

Herein, input content may include any one of text and an image containing text.

According to the present implementation, a typeface creation control may be shown in a creation interface for a user, and upon detecting a trigger operation with regard to the typeface creation control, it is determined that a first creation operation with regard to the creation interface is detected. Based on the needs of text typeface analysis, a number of characters needed in input content may be configured, to ensure that a display typeface of subtitles of the third subtitle display mode may be determined based on input content.

Thus, based on input content of a user, a display typeface of subtitles may be determined, creating a third subtitle display mode satisfying personalized needs of a user.

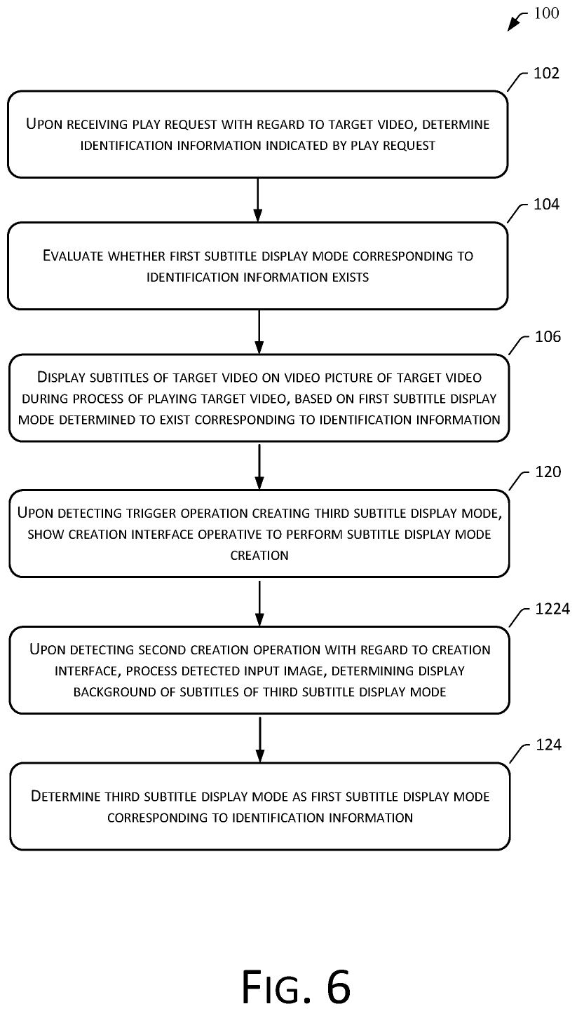

FIG. 6 illustrates a flowchart of a video subtitle display method 100 according to an example embodiment of the present disclosure. In a possible implementation, as shown by FIG. 6, step 122 may include step 1224.

In step 1224, upon detecting a second creation operation with regard to the creation interface, a detected input image is processed, determining a display background of subtitles of the third subtitle display mode.

According to the present implementation, a background creation control may be shown in a creation interface for a user, and upon detecting a trigger operation with regard to the background creation control, it is determined that a second creation operation with regard to the creation interface is detected. Then, based on an input image input by the user, size, pixels and the like of the input image are processed, and the processed input image is determined as a display background of subtitles of the third subtitle display mode.

Thus, based on an input image of a user, a display background of subtitles may be determined, creating a third subtitle display mode satisfying personalized needs of a user.

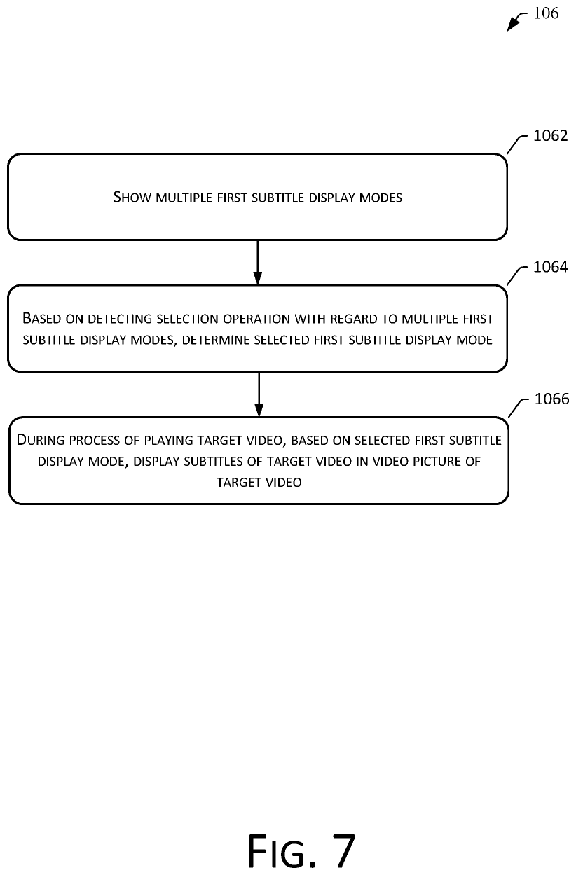

FIG. 7 illustrates a flowchart of step 106 of a video subtitle display method 100 according to an example embodiment of the present disclosure. In a possible implementation, as shown by FIG. 7, first subtitle display modes corresponding to the identification information are multiple first subtitle display modes, and step 106 may include step 1062 to step 1066.

In step 1062, multiple first subtitle display modes are shown.

In step 1064, based on detecting a selection operation with regard to the multiple first subtitle display modes, a selected first subtitle display mode is determined.

In step 1066, during a process of playing a target video, based on a selected first subtitle display mode, subtitles of the target video are displayed in a video picture of the target video.

According to the present implementation, a new window or popup may be created, and multiple first subtitle display modes shown therein for a user. Upon detecting a click, a double click and such selection operations upon a certain first subtitle display mode, a selected first subtitle display mode is determined based on the selection operation. During a process of playing a target video, based on the selected first subtitle display mode, subtitles of the target video are displayed in a video picture of the target video.

According to the present implementation, a user may, before the target video is played, perform selection among multiple first subtitle display modes, and may, during the playback procedure of the target video, perform selection among multiple first subtitle display modes. The present disclosure shall not be limiting thereto.

In this manner, when first subtitle display modes corresponding to the identification information are multiple first subtitle display modes, subtitles of the target video may be played based on a selection of the user, satisfying individualized needs of the user.

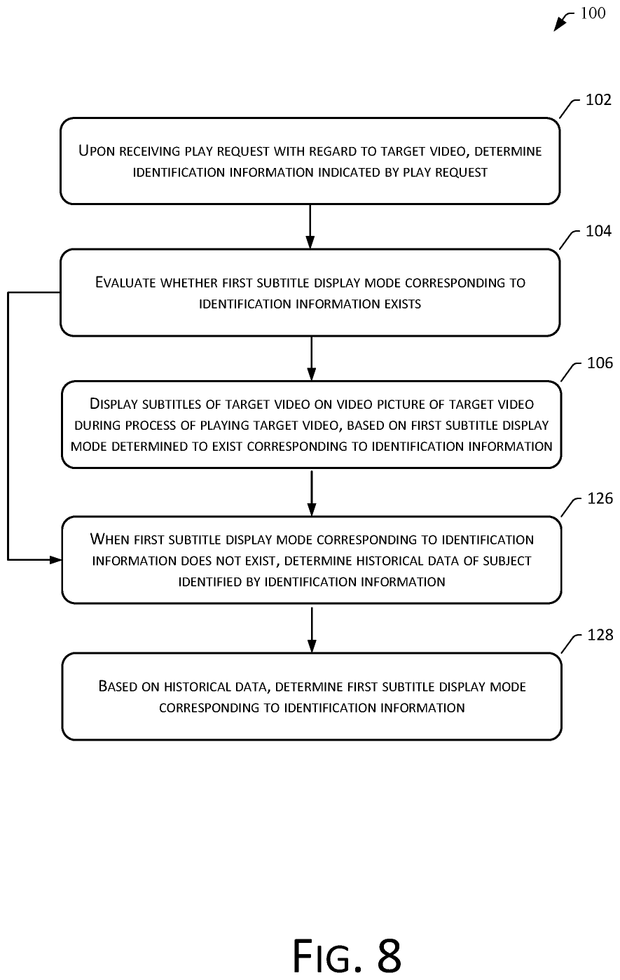

FIG. 8 illustrates a flowchart of a video subtitle display method 100 according to an example embodiment of the present disclosure. In a possible implementation, as shown by FIG. 8, the method may further include step 126 and step 128.

In step 126, when a first subtitle display mode corresponding to the identification information does not exist, historical data of a subject identified by the identification information is determined. Herein, historical data includes at least one of historical behavior data and user profile data of the subject.

According to the present implementation, historical behavior data of a subject may include historical playback data of a terminal, historical behavior data of a user and such data having correlation to behavior habits of a user. For example, historical behavior data of a user may include a browsing history of a user, subtitle display modes used by a user during a procedure of viewing a video, and the like. A user profile, also called a crowd profile, is a labeled profile abstracted from user demographic information, social connections, preference habits, consumer behavior, and such information. User profile data may include data representing user profiles, such as user gender, age, occupation, preferences and the like.

In step 128, based on historical data, a first subtitle display mode corresponding to the identification information is determined.

According to the present implementation, historical data may be input into a feature determination model for processing, obtaining behavior features. Herein, a feature determination model is derived from training based on reference data and standard features of the reference data. Then, based on association relationships between behavior features and subtitle display modes determined in advance, determining a corresponding first subtitle display mode based on the association relationships and historical features may be facilitated.

According to the present implementation, historical data of a subject identified by the obtained identification information may be input into a feature determination model trained in advance for processing, to obtain behavior features of the subject.

According to the present implementation, a feature determination model may be derived by training in advance based on reference data and standard features of the reference data. For example, massive reference data (such as historical data of users of some video website) may be collected, and, by manual recognition based on the reference data, its standard features may be determined. Alternatively, massive reference data (such as historical data of users of some video website having known behavior features) may be collected, and a feature determination model may be derived from training based on reference data and standard features of the reference data.

According to the present implementation, machine learning (ML), deep learning, and such methods may be employed to perform training using reference data and standard features of the reference data, obtaining the needed feature determination model. Persons skilled in the art may, based on actual needs, configure the manner of obtaining a feature determination model.

In this manner, based on historical data of a subject identified by identification information, behavior features of a subject are determined and then based on the behavior features, a first subtitle display mode is determined. The determined subtitle display may satisfy the subject's viewing needs for the subtitles.

According to the present example embodiment, display modes of each interface and each control of each interface, trigger operations of each control, and the like may be configured based on actual needs, and the present disclosure shall not be limiting thereto.

It should be noted that, although the above-mentioned example embodiments have introduced, as examples, video subtitle display methods as above, persons skilled in the art may understand that the present disclosure is not limited to thus. In actuality, users may entirely flexibly enact each step based on personal preferences and/or practical application scenarios, as long as in conformity with technical solutions of the present disclosure.

Video subtitle display methods provided by example embodiments of the present disclosure, upon receiving a play request with regard to a target video, determine identification information indicated by the play request; evaluate whether a first subtitle display mode corresponding to the identification information exists; and displaying subtitles of a target video on a video picture of the target video during a process of playing the target video, based on a first subtitle display mode determined to exist corresponding to the identification information. Thus a video subtitle display mode may change based on differences between first subtitle display modes corresponding to different identification information, satisfying viewing needs of different users for subtitles in video pictures.

### Example Application

Below, with “a user watches a TV series through a mobile phone” as an exemplary application scenario, an application example based on example embodiments of the present disclosure is given, facilitating understanding a flow of video subtitle display methods. Persons skilled in the art should understand that the below application example merely arises from the objective of understanding example embodiments of the present disclosure, and should not be considered as limiting example embodiments of the present disclosure.

Some user A, through a mobile phone, watches a TV series liked by the user (that is, a target video). The mobile phone may, based on a TV series selected by user A and determined identification information, generate a play request. Herein, a subject identified by identification information may be the mobile phone, a client terminal loaded on the mobile phone playing the TV series, and an account of user A. For conciseness, the present example shall use the account of user A as an example.

The mobile phone, based on the play request, determines identification information, and based on the identification information evaluates whether a first subtitle display mode corresponding to the identification information exists.

If one exists, the mobile phone is directly controlled to display subtitles of a TV series in a video picture of the TV series during a process of playing the TV series, based on the first subtitle display mode corresponding to the identification information.

If one does not exist, historical data of the identified user A (the subject) is obtained. The historical data is input into a feature determination model for processing, obtaining behavior features of user A. Then, based on the behavior features, a first subtitle display mode is determined. This facilitates controlling the mobile phone to display subtitles of a TV series in a video picture of the TV series during a process of playing the TV series, based on the determined subtitle display mode.

Herein, the above-mentioned specific implementation process refers to the above-mentioned related description of the present disclosure of corresponding steps.

Thus, subtitles of a TV series may be displayed in a video picture of the TV series during a process of playing the TV series for a user, based on a first subtitle display mode corresponding to an account of user A, satisfying viewing needs of the user for subtitles in a video picture.

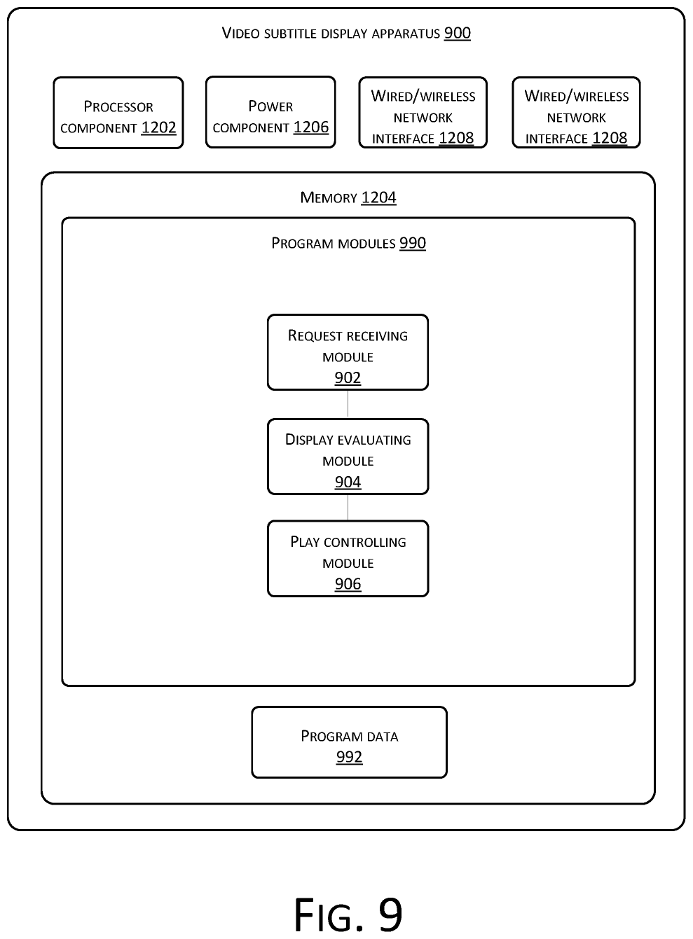

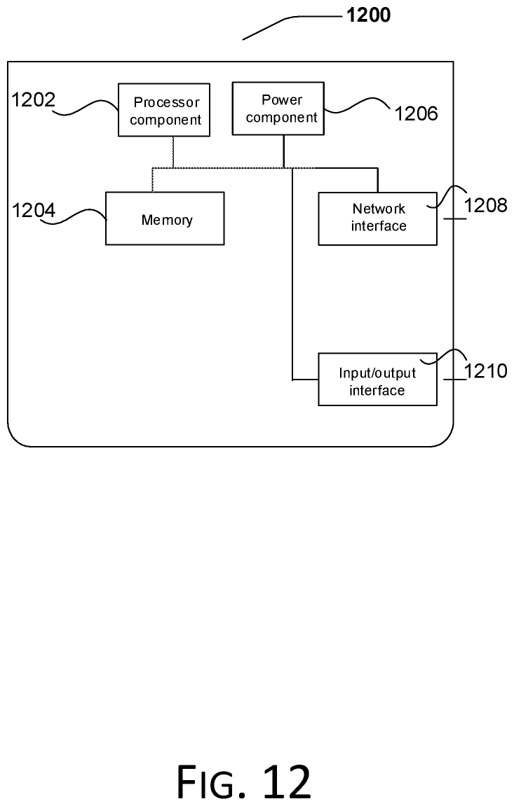

FIG. 9 illustrates a block diagram of a video subtitle display apparatus 900 according to an example embodiment of the present disclosure. As illustrated by FIG. 9, the apparatus 900 may be applied to a mobile phone, a computer and such terminals, and may also be applied to a server. The apparatus 900 may be implemented as, for example, a video subtitle display apparatus as illustrated by FIG. 12 described below, including a processor component 1202, memory 1204, a power component 1206, a wired or wireless network interface 1208, and an input/output (I/O) interface 1210 as described with reference to FIG. 12 below. The apparatus 900 includes a request receiving module 902, a display evaluating module 904 and a play controlling module 906. The request receiving module 902 is stored in the memory 1204 and configured to be executable by the processor component 1202 to cause the processor component 1202 to, upon receiving a play request with regard to a target video, determine identification information indicated by the play request. The display evaluating module 904 is stored in the memory 1204 and configured to be executable by the processor component 1202 to cause the processor component 1202 to cause the processor component 1202 to evaluate whether a first subtitle display mode corresponding to the identification information exists. The play controlling module 906 is stored in the memory 1204 and configured to be executable by the processor component 1202 to cause the processor component 1202 to display subtitles of a target video on a video picture of the target video during a process of playing the target video, based on a first subtitle display mode determined to exist corresponding to the identification information.

In implementations, the memory 1304 may include program modules 990 and program data 992. The program modules 992 may include one or more of the modules as described above.

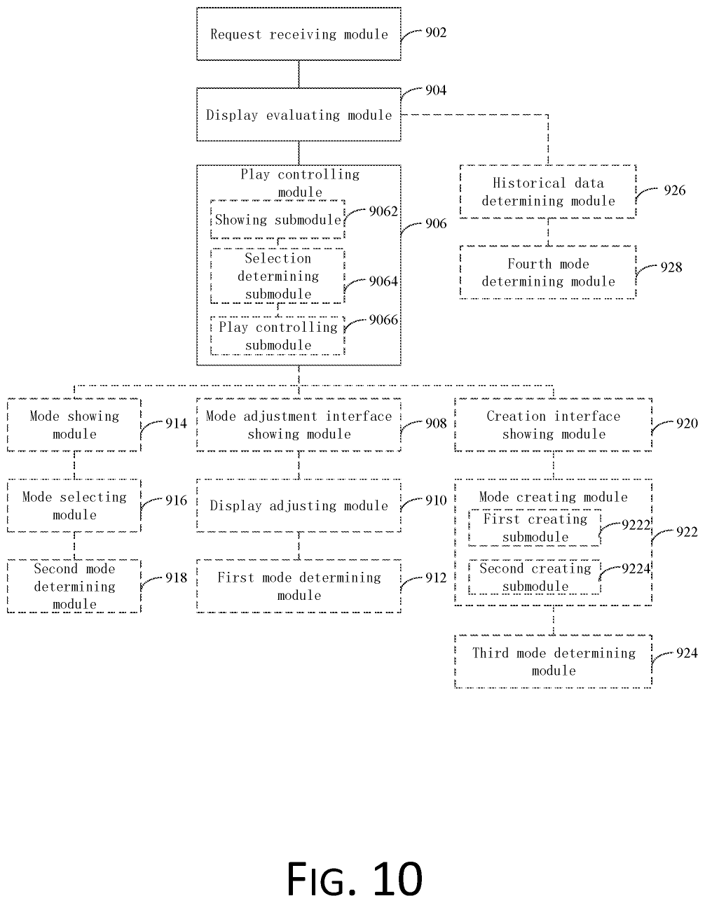

FIG. 10 illustrates a block diagram of a video subtitle display apparatus 900 according to an example embodiment of the present disclosure.

According to a possible implementation, as illustrated by FIG. 10, the apparatus 900 may further include a mode adjustment interface showing module 908, a display adjustment module 910 and a first mode determining module 912. The mode adjustment interface showing module 908 is stored in the memory 1204 and configured to be executable by the processor component 1202 to cause the processor component 1202 to, based on a detected trigger operation performing adjustment upon a subtitle display mode, show a mode adjustment interface operative to adjust a subtitle display mode. The display adjustment module 910 is stored in the memory 1204 and configured to be executable by the processor component 1202 to cause the processor component 1202 to, based on a detected adjustment operation with regard to the mode adjustment interface, perform display adjustment upon the first subtitle display mode, and determine an adjusted first subtitle display mode. The first mode adjusting module 912 is stored in the memory 1204 and configured to be executable by the processor component 1202 to cause the processor component 1202 to determine an adjusted first subtitle display mode as a first subtitle display mode corresponding to the identification information. Herein, display adjustment includes at least one of display position adjustment, display typeface adjustment, display color adjustment, display size adjustment, arrangement adjustment, display background adjustment and display background transparency adjustment.

According to a possible implementation, as illustrated by FIG. 10, the apparatus 900 may further include a mode showing module 914, a mode selecting module 916 and a second mode determining module 918. The mode showing module 914 is stored in the memory 1204 and configured to be executable by the processor component 1202 to cause the processor component 1202 to show, upon detecting a trigger operation performing selection among subtitle display modes, multiple second subtitle display modes pending selection. The mode selecting mode 916 is stored in the memory 1204 and configured to be executable by the processor component 1202 to cause the processor component 1202 to determine, based on a detected selection operation with regard to multiple second subtitle display modes, a selected second subtitle display mode. The second mode determining module 918 is stored in the memory 1204 and configured to be executable by the processor component 1202 to cause the processor component 1202 to determine the selected second subtitle display mode as a first subtitle display mode corresponding to identification information.

According to a possible implementation, as illustrated by FIG. 10, the apparatus 900 may further include a creation interface showing module 920, a mode creating module 922 and a third mode determining module 924. The creation interface showing module 920 is stored in the memory 1204 and configured to be executable by the processor component 1202 to cause the processor component 1202 to, upon detecting a trigger operation creating a third subtitle display mode, show a creation interface operative to perform subtitle display mode creation. The mode creating module 922 is stored in the memory 1204 and configured to be executable by the processor component 1202 to cause the processor component 1202 to, based on a detected creation operation with regard to the creation interface, create a third subtitle display mode. The third mode determining module 924 is stored in the memory 1204 and configured to be executable by the processor component 1202 to cause the processor component 1202 to determine the third subtitle display mode as a first subtitle display mode corresponding to identification information.

According to a possible implementation, as illustrated by FIG. 10, the mode creating module 922 may include a first creating submodule 9222. The first creating submodule 9222 is stored in the memory 1204 and configured to be executable by the processor component 1202 to cause the processor component 1202 to, upon detecting a first creation operation with regard to the creation interface, perform text typeface analysis upon detected input content, and determine a display typeface of subtitles of the third subtitle display mode based on analysis results. Herein, input content may include any one of text and an image containing text.

According to a possible implementation, as illustrated by FIG. 10, the mode creating module 922 may include a second creating submodule 9224. The second creating submodule 9224 is stored in the memory 1204 and configured to be executable by the processor component 1202 to cause the processor component 1202 to, upon detecting a second creation operation with regard to the creation interface, process a detected input image, determining a display background of subtitles of the third subtitle display mode.

According to a possible implementation, as illustrated by FIG. 10, first subtitle display modes corresponding to the identification information are multiple first subtitle display modes. Herein, the play controlling module 906 may include a showing submodule 9062, a selection determining submodule 9064 and a playing controlling submodule 9066. The showing submodule 9062 is stored in the memory 1204 and configured to be executable by the processor component 1202 to cause the processor component 1202 to show multiple first subtitle display modes. The selection determining submodule 9064 is stored in the memory 1204 and configured to be executable by the processor component 1202 to cause the processor component 1202 to, based on detecting a selection operation with regard to the multiple first subtitle display modes, determine a selected first subtitle display mode. The play controlling submodule 9066 is stored in the memory 1204 and configured to be executable by the processor component 1202 to cause the processor component 1202 to, during a process of playing a target video, based on a selected first subtitle display mode, display subtitles of the target video in a video picture of the target video.

According to a possible implementation, as illustrated by FIG. 10, the apparatus 900 may further include a historical data determining module 926 and a fourth mode determining module 928. The historical data determining module 926 is stored in the memory 1204 and configured to be executable by the processor component 1202 to cause the processor component 1202 to, when a first subtitle display mode corresponding to the identification information does not exist, determine historical data of a subject identified by the identification information. The fourth mode determining module 928 is stored in the memory 1204 and configured to be executable by the processor component 1202 to cause the processor component 1202 to, based on historical data, determine a first subtitle display mode corresponding to the identification information. Herein, historical data may include at least one of historical behavior data and user profile data of the subject.

According to a possible implementation, a subject identified by identification information may include at least one of a terminal, a client terminal loaded by a terminal, and an account logged in through a terminal.

Identification information may include at least one of an IP address of a terminal, an identifier of an account logged in through a terminal, an identifier of a client terminal loaded by a terminal, an identifier of an account logged in through a client terminal, and an identifier of a terminal.

According to a possible implementation, a first subtitle display mode may include at least one of the following:

A display position, a display typeface, a display color, a display size, an arrangement, a display background, and a transparency of a display background of subtitles on the video picture.

It should be noted that, although the above-mentioned example embodiments have introduced, as examples, video subtitle display apparatuses as above, persons skilled in the art may understand that the present disclosure is not limited to thus. In actuality, users may entirely flexibly enact each module based on personal preferences and/or practical application scenarios, as long as in conformity with technical solutions of the present disclosure.

Video subtitle display apparatuses provided by example embodiments of the present disclosure include: a request receiving module configured to, upon receiving a play request with regard to a target video, determine identification information indicated by the play request; a display evaluating module configured to evaluate whether a first subtitle display mode corresponding to the identification information exists; a play controlling module configured to display subtitles of a target video on a video picture of the target video during a process of playing the target video, based on a first subtitle display mode determined to exist corresponding to the identification information. Thus a video subtitle display mode may change based on differences between first subtitle display modes corresponding to different identification information, satisfying viewing needs of different users for subtitles in video pictures.

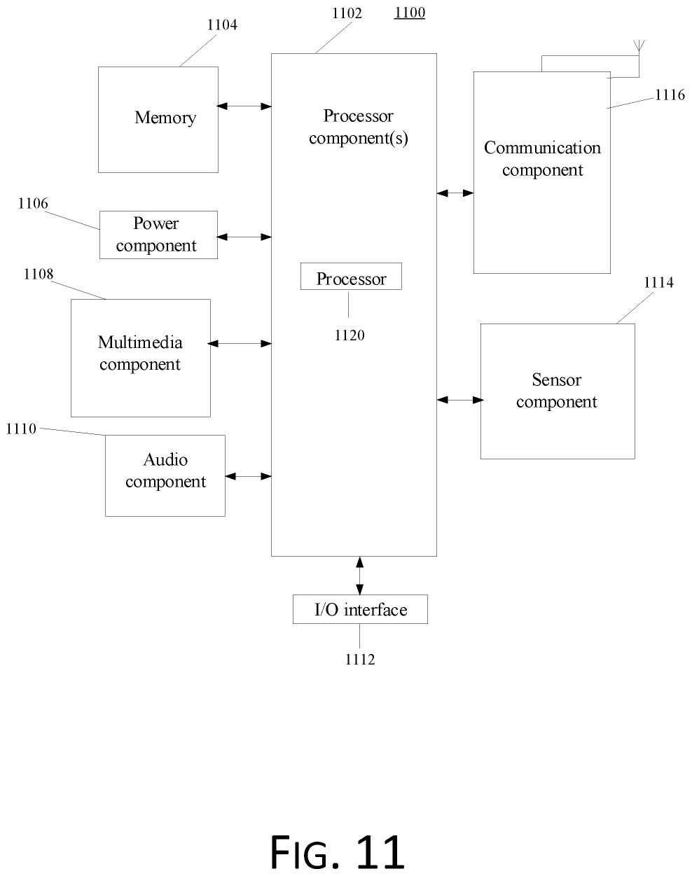

FIG. 11 illustrates a block diagram of a video subtitle display apparatus 1100 according to an example embodiment of the present disclosure. For example, an apparatus 1100 may be a mobile phone, computer, digital broadcasting terminal, messaging device, game console, tablet device, medical device, fitness device, personal digital assistant and the like.

Referring to FIG. 11, the apparatus 1100 may include one or more of the below components: one or more processor components 1102, a memory 1104, a power component 1106, a multimedia component 1108, an audio component 1110, an input/output (I/O) interface 1112, a sensor component 1114, and a communication component 1116.

The one or more processor components 1102 usually control overall operation of the apparatus 1100, such as operations associated with display, phone calls, data communication, camera operations and recording operations. The one or more processor components 1102 may include one or more processors 1120 to execute instructions, and carry out all or some steps of the above-mentioned methods. Additionally, the one or more processor components 1102 may include one or more modules, facilitating interactions between the one or more processor components 1102 and other components. For example, the one or more processor components 1102 may include a multimedia module, facilitating interactions between the multimedia component 1108 and the one or more processor components 1102.

The memory 1104 is configured to store various formats of data and support operations of the apparatus 1100. Examples of data include any instructions, contact data, phone book data, information, images, videos and the like of applications or methods utilized in operations on the apparatus 1100. The memory 1104 may be implemented by any type of volatile or non-volatile storage device or combinations thereof, such as static random access memory (SRAM), electrically erasable programmable read only memory (EEPROM), erasable programmable read only memory (EPROM), programmable read only memory (PROM), read-only memory (ROM), magnetic memory, flash memory, magnetic disks or optical discs.

The power component 1106 provides electrical power to the various components of the apparatus 1100. The power component 1106 may include a power management system, one or more power supplies, and other components associated with generating, managing and allocating electrical power for the apparatus 1100.

The multimedia component 1108 includes a screen providing an output interface between the apparatus 1100 and a user. According to some example embodiments, the screen may include a liquid crystal display (LCD) and a touch panel (TP). If the screen includes a touch panel, the screen may be implemented as a touchscreen, receiving input signals of the user. A touch panel includes one or more touch sensors which sense touches, swipes and gestures upon the touch panel. The touch sensors may not merely sense boundaries of touch or swipe gestures, but also detect duration and pressure associated with touch or swipe gestures. According to some example embodiments, the multimedia component 1108 includes a front camera and/or rear camera. When the apparatus 1100 is in an operation mode, such as an image capture mode or a video mode, the front camera and/or the rear camera may receive external multimedia data. Each front camera and rear camera may be a stationary optical lens system or have focal length and optical zoom capability.

The audio component 1110 is configured to output and/or input audio signals. For example, the audio component 1110 includes a microphone; when the apparatus 1100 is in an operation mode, such as a calling mode, a recording mode and a voice recognition mode, the microphone is configured to receive external audio signals. The received audio signals may be further stored on the memory 1104 or sent via the communication component 1116. According to some example embodiments, the audio component 1110 further includes a speaker, utilized to output audio signals.

The I/O interface 1112 provides an interface between the processing component 1102 and a peripheral interface module, where the above-mentioned peripheral interface module may be a keyboard, a click wheel, a button and the like. Such buttons may include, without limitation: a home button, a volume button, a startup button and a lock button.

The sensor component 1114 includes one or more sensors, utilized to provide state assessment of various aspects for the apparatus 1100. For example, the sensor component 1114 may detect an on/off state of the apparatus 1100, and relative positioning of components, such as when the components are a monitor and a keypad of the apparatus 1100. The sensor component 1114 may further detect position changes of the apparatus 1100 or a component of the apparatus 1100, whether contact exists or not between a user and the apparatus 1100, orientation or acceleration/deceleration of the apparatus 1100, and temperature changes of the apparatus 1100. The sensor component 1114 may include a proximity sensor, configured to detect the existence of nearby objects while there is no physical contact. The sensor component 1114 may further include a light sensor, such as a CMOS or CCD image sensor, utilized in an imaging application. According to some example embodiments, the sensor component 1114 may further include a speed sensor, a gyro sensor, a magnetic sensor, a pressure sensor or a temperature sensor.

The communication component 1116 is configured to facilitate communication by a wired or a wireless fashion between the apparatus 1100 and other devices. The apparatus 1100 may access a wireless network based on communication protocols, such as Wi-Fi, 2G or 3G, or a combination thereof. According to an exemplary embodiment, the communication component 1116 receives broadcast signals or information associated with broadcasting from an external broadcast management system by a broadcast channel. According to an exemplary embodiment, the communication component 1116 further includes a near field communication (NFC) module, to boost short-range communication. For example, a NFC module may be implemented based on radio frequency identification (RFID) technology, Infrared Data Association (IrDA) technology, ultra-wideband (UWB) technology, Bluetooth (BT) technology and other technologies.

According to example embodiments, the apparatus 1100 may be implemented by one or more application-specific integrated circuits (ASICs), digital signal processors (DSPs), digital signal processing devices (DSPDs), programmable logic devices (PLDs), field programmable gate arrays (FPGAs), controllers, microcontrollers, microprocessors or other electronic components, utilized to execute the above-mentioned methods.

According to example embodiments, a non-volatile computer-readable storage medium is further provided, such as a memory 1104 including computer program instructions, where the above-mentioned computer program instructions may be executed by a processor 1120 of the apparatus 1100 to carry out the above-mentioned methods.

FIG. 12 illustrates a block diagram of a video subtitle display apparatus 1200 according to an example embodiment of the present disclosure. For example, apparatus 1200 may be provided as a server. Referring to FIG. 12, the apparatus 1200 includes a processor component 1202, which further includes one or more processors, and memory resources represented by memory 1204, utilized to store instructions executable by the processor component 1202, such as applications. Applications stored on the memory 1204 may include one or more than one module, each corresponding to a set of instructions. Additionally, the processor component 1202 is configured to execute instructions, to execute the above-mentioned methods.

The apparatus 1200 may further include a power component 1206 configured to execute power management of the apparatus 1200, a wired or wireless network interface 1208 configured to connect the apparatus 1200 to a network, and an input/output (I/O) interface 1210. The apparatus 1200 may operate based on an operating system stored on the memory 1204, such as Windows Server™, Mac OS X™, Unix™, Linux™, FreeBSD™ or similar.

According to example embodiments, a non-volatile computer-readable storage medium is further provided, such as a memory 1204 including computer program instructions, where the above-mentioned computer program instructions may be executed by a processor component 1202 of the apparatus 1200 to carry out the above-mentioned methods.

The present disclosure may be a system, method and/or computer program product. A computer program product may include a computer-readable storage medium, wherein computer-readable program instructions utilized to cause a processor to implement each aspect of the present disclosure are contained.

A computer-readable storage medium may be a tangible device capable of saving and storing instructions employed in instructing an executing device. A computer-readable storage medium, for example, may be—but not being limited to—an electrical storage device, a magnetic storage device, an optical storage device, an electromagnetic storage device, a semiconductor storage device or any suitable combinations of the above. More particular examples of a computer-readable storage medium (listed non-exhaustively) include: a portable computer disk, a hard disk, a random-access memory (RAM), a read-only memory (ROM), an electronically erasable programmable read-only memory (EEPROM), a static random access memory (SRAM), a compact disk read-only memory (CD-ROM), a digital versatile disc (DVD), a memory stick, a floppy disk, a mechanical encoder device, a punch card or grooved structure having instructions stored thereon, or any suitable combination of the above. A computer-readable storage medium employed herein shall not be interpreted as a transitory signal itself, such as a radio wave or other free-propagating electromagnetic wave, electromagnetic waves propagating through a waveguide or other transmission medium (such as light pulses through a fiber optic cable), or electrical signals propagating through a wire.

Computer-readable program instructions as described herein may be downloaded from a computer-readable storage medium onto each computing/processor device, or may be downloaded through a network such as the Internet, a local area network, a wide area network and/or a wireless network onto an external computer or external storage device. A network may include a copper transmission cable, fiber optic transmission, wireless transmission, a router, a firewall, a switch, a gateway, a computer and/or an edge server. Network adapter cards and/or network interfaces of each computing/processor device receive computer-readable program instructions from a network, and forward the computer-readable program instructions, for storage on computer-readable storage media of each computing/processor device.

Computer-readable program instructions utilized to execute operations of the present disclosure may be assembly instructions, instruction set architecture (ISA) instructions, machine instructions, machine-related instructions, microcode, firmware instructions, status setting data, or source code or object code written in one or any combination of more than one programming languages, the programming languages including object oriented programming languages such as Smalltalk, C++ and the like, and conventional procedural programming languages such as C or similar programming languages. Computer-readable program instructions may be entirely executed on a user computer, partially executed on a user computer, executed as a standalone software package, executed partially on a user computer and partially on a remote computer, or executed entirely on a remote computer or server. In scenarios involving a remote computer, the remote computer may, through any type of network—including a local area network (LAN) or a wide area network (WAN)—connect to a user computer, or, may connect to a remote computer (such as employing an Internet service provider to connect through the Internet). According to some example embodiments, through employing status information of computer-readable program instructions to personalize custom electronic circuits, such as programmable logic circuits, field programmable gate arrays (FPGAs) or programmable logic arrays (PLAs), the electronic circuits may execute computer-readable program instructions, thereby implementing various aspects of the present disclosure.

Herein, referring to flowcharts and/or block diagrams of methods, apparatuses (systems) and computer program products of example embodiments of the present disclosure, various aspects of the present disclosure are described. It should be understood that each box of the flowcharts and/or block diagrams and combinations of each box of the flowcharts and/or block diagrams all may be implemented by computer-readable program instructions.

These computer-readable program instructions may be provided for processors of general-purpose computers, dedicated-purpose computers or other programmable data processing apparatuses, thereby manufacturing a type of machine, so that when these instructions are executed by processors of computers or other programmable data processing apparatuses, apparatuses implementing functionalities/acts prescribed by one or more boxes of the flowcharts and/or block diagrams are yielded. These computer-readable program instructions may also be stored on computer-readable storage media, and these instructions cause computers, programmable data processing apparatuses and/or other devices to work in specific ways. Thereby, computer-readable media having instructions stored include a manufactured product, which includes instructions that implement functionalities/acts prescribed by one or more boxes of the flowcharts and/or block diagrams.

The computer-readable program instructions may also be loaded onto a computer, other programmable data processing apparatus, or other device, causing the computer, other programmable data processing apparatus, or other device to execute a series of operational steps thereon, yielding a computer-implemented process, thereby causing instructions executed on the computer, other programmable data processing apparatus, or other device to implement functionalities/acts prescribed by one or more boxes of the flowcharts and/or block diagrams.

Flowcharts and block diagrams of the drawings show architectures, functionalities and operations that may be implemented for systems, methods and computer program products based on multiple example embodiments of the present disclosure. In this regard, each box of the flowcharts or block diagrams may represent a part of a module, program segment or instruction, the part of a module, program segment or instruction containing one or more executable instructions utilized to implement prescribed logic functions. According to some substitute implementations, labeled functionalities in boxes may occur in an order different from that labeled in the drawings. For example, two consecutive boxes may actually execute essentially in parallel, and sometimes they may execute in the opposite order, depending on the functionalities involved. It should also be noted that each box of the flowcharts and/or block diagrams, and combinations of each box of the flowcharts and/or block diagrams, may be implemented using a dedicated-purpose hardware-based system executing the prescribed functionalities or acts, or may be implemented using a combination of hardware and computer instructions.

With regard to each example embodiment of the present disclosure already described above, the above-mentioned descriptions are exemplary, and not exhaustive, nor limited to each example embodiment divulged herein. Without deviating from the scope and spirit of each example embodiment of the description, many alterations and modifications will be readily apparent to persons of ordinary skill in the art. Choices of words in the present text are designed to best explain for each example embodiment its principles, practical applications or technological improvements upon related technology, or to enable other persons of ordinary skill in the art to understand each example embodiment divulged by the present disclosure.

The present disclosure may further be understood with clauses as follows.

Clause 1, a video subtitle display method, comprising:
determining, upon receiving a play request with regard to a target video, identification information indicated by the play request;
evaluating whether a first subtitle display mode corresponding to the identification information exists; and
displaying subtitles of a target video on a video picture of the target video during a process of playing the target video, based on a first subtitle display mode determined to exist corresponding to the identification information.

Clause 2 may include the method of clause 1, further comprising:
showing, based on a detected trigger operation performing adjustment upon a subtitle display mode, a mode adjustment interface operative to adjust a subtitle display mode;
performing, based on a detected adjustment operation with regard to the mode adjustment interface, display adjustment upon the first subtitle display mode, and determining an adjusted first subtitle display mode; and
determining an adjusted first subtitle display mode as a first subtitle display mode corresponding to the identification information;

wherein display adjustment comprises at least one of display position adjustment, display typeface adjustment, display color adjustment, display size adjustment, arrangement adjustment, display background adjustment and display background transparency adjustment.

Clause 3 may include the method of clause 1, further comprising:
showing, upon detecting a trigger operation performing selection among subtitle display modes, multiple second subtitle display modes pending selection;
determining, based on a detected selection operation with regard to multiple second subtitle display modes, a selected second subtitle display mode; and
determining the selected second subtitle display mode as a first subtitle display mode corresponding to identification information.

Clause 4 may include the method of clause 1, further comprising:
showing, upon detecting a trigger operation creating a third subtitle display mode, a creation interface operative to perform subtitle display mode creation;
creating, based on a detected creation operation with regard to the creation interface, a third subtitle display mode; and
determining the third subtitle display mode as a first subtitle display mode corresponding to identification information.

Clause 5 may include the method of clause 4, wherein creating, based on a detected creation operation with regard to the creation interface, a third subtitle display mode comprises:
performing, upon detecting a first creation operation with regard to the creation interface, text typeface analysis upon detected input content, and determining a display typeface of subtitles of the third subtitle display mode based on analysis results;

wherein input content comprises one of: text, and an image containing text.

Clause 6 may include the method of clause 4, wherein creating, based on a detected creation operation with regard to the creation interface, a third subtitle display mode comprises:
processing, upon detecting a second creation operation with regard to the creation interface, a detected input image, determining a display background of subtitles of the third subtitle display mode.

Clause 7 may include the method of clause 1, wherein first subtitle display modes corresponding to the identification information are multiple first subtitle display modes, and;

wherein displaying subtitles of a target video on a video picture of the target video during a process of playing the target video, based on a first subtitle display mode determined to exist corresponding to the identification information comprises:
showing multiple first subtitle display modes;
determining, based on detecting a selection operation with regard to the multiple first subtitle display modes, a selected first subtitle display mode; and
displaying, during a process of playing a target video, based on a selected first subtitle display mode, subtitles of the target video in a video picture of the target video.

Clause 8 may include the method of clause 1, further comprising:
determining, when a first subtitle display mode corresponding to the identification information does not exist, historical data of a subject identified by the identification information; and
determining, based on historical data, a first subtitle display mode corresponding to the identification information;

wherein the historical data comprises at least one of: historical behavior data of the subject, and user profile data of the subject.

Clause 9 may include the method of clause 1, wherein a subject identified by identification information comprises at least one of a terminal, a client terminal loaded by a terminal, and an account logged in through a terminal; and

identification information comprises at least one of an IP address of a terminal, an identifier of an account logged in through a terminal, an identifier of a client terminal loaded by a terminal, an identifier of an account logged in through a client terminal, and an identifier of a terminal.

Clause 10 may include the method of clause 1, wherein a first subtitle display mode comprises at least one of:
a display position of subtitles on the video picture, a display typeface of subtitles on the video picture, a display color of subtitles on the video picture, a display size of subtitles on the video picture, an arrangement of subtitles on the video picture, a display background of subtitles on the video picture, and a transparency of a display background of subtitles on the video picture.

Clause 11, a video subtitle display apparatus, comprising:
a request receiving module configured to determine, upon receiving a play request with regard to a target video, identification information indicated by the play request;
a display evaluating module configured to evaluate whether a first subtitle display mode corresponding to the identification information exists; and
a play controlling module configured to display subtitles of a target video on a video picture of the target video during a process of playing the target video, based on a first subtitle display mode determined to exist corresponding to the identification information.

Clause 12 may include the apparatus of clause 11, further comprising:
a mode adjustment interface showing module configured to show, based on a detected trigger operation performing adjustment upon a subtitle display mode, a mode adjustment interface operative to adjust a subtitle display mode;
a display adjustment module configured to perform, based on a detected adjustment operation with regard to the mode adjustment interface, display adjustment upon the first subtitle display mode, and determine an adjusted first subtitle display mode; and
a first mode adjusting module configured to determine an adjusted first subtitle display mode as a first subtitle display mode corresponding to the identification information;

wherein display adjustment comprises at least one of display position adjustment, display typeface adjustment, display color adjustment, display size adjustment, arrangement adjustment, display background adjustment and display background transparency adjustment.

Clause 13 may include the apparatus of clause 11, further comprising:
a mode showing module configured to show, upon detecting a trigger operation performing selection among subtitle display modes, multiple second subtitle display modes pending selection;
a mode selecting mode configured to determine, based on a detected selection operation with regard to multiple second subtitle display modes, a selected second subtitle display mode; and
a second mode determining module configured to determine the selected second subtitle display mode as a first subtitle display mode corresponding to identification information.

Clause 14 may include the apparatus of claim 11, further comprising:
a creation interface showing module configured to show, upon detecting a trigger operation creating a third subtitle display mode, a creation interface operative to perform subtitle display mode creation;
a mode creating module configured to create, based on a detected creation operation with regard to the creation interface, a third subtitle display mode; and
a third mode determining module configured to determine the third subtitle display mode as a first subtitle display mode corresponding to identification information.

Clause 15 may include the apparatus of clause 14, wherein the mode creating module further comprises:
a first creating submodule configured to perform, upon detecting a first creation operation with regard to the creation interface, text typeface analysis upon detected input content, and determine a display typeface of subtitles of the third subtitle display mode based on analysis results;

wherein input content comprises one of: text, and an image containing text.

Clause 16 may include the apparatus of clause 14, wherein the mode creating module further comprises:
a second creating submodule configured to process, upon detecting a second creation operation with regard to the creation interface, a detected input image, determining a display background of subtitles of the third subtitle display mode.

Clause 17 may include the apparatus of clause 11, wherein first subtitle display modes corresponding to the identification information are multiple first subtitle display modes, and

wherein the play controlling module comprises:
a showing submodule configured to show multiple first subtitle display modes;
a selection determining submodule configured to determine, based on detecting a selection operation with regard to the multiple first subtitle display modes, a selected first subtitle display mode; and
a play controlling submodule configured to display, during a process of playing a target video, based on a selected first subtitle display mode, subtitles of the target video in a video picture of the target video.

Clause 18 may include the apparatus of clause 11, further comprising:
a historical data determining module configured to determine, when a first subtitle display mode corresponding to the identification information does not exist, historical data of a subject identified by the identification information; and
a fourth mode determining module configured to determine, based on historical data, a first subtitle display mode corresponding to the identification information;

wherein the historical data comprises at least one of: historical behavior data of the subject, and user profile data of the subject.

Clause 19 may include the apparatus of clause 11, wherein a subject identified by identification information comprises at least one of: a terminal, a client terminal loaded by a terminal, and an account logged in through a terminal; and

identification information comprises at least one of: an IP address of a terminal, an identifier of an account logged in through a terminal, an identifier of a client terminal loaded by a terminal, an identifier of an account logged in through a client terminal, and an identifier of a terminal.

Clause 20 may include the apparatus of clause 11, wherein a first subtitle display mode comprises at least one of:

a display position of subtitles on the video picture, a display typeface of subtitles on the video picture, a display color of subtitles on the video picture, a display size of subtitles on the video picture, an arrangement of subtitles on the video picture, a display background of subtitles on the video picture, and a transparency of a display background of subtitles on the video picture.

Clause 21, a video subtitle display apparatus, comprising:
a processor; and
memory utilized to store instructions executable by the processor;

wherein the processor is configured to execute the methods of any one of the clauses 1 to 10.

Clause 22, a non-volatile computer-readable storage medium, wherein computer program instructions are stored thereon, the computer program instructions being executable by a processor to implement the methods of any one of the clauses 1 to 10.

What is claimed is:

1. A method comprising:
determining, upon receiving a play request with regard to a target video, identification information indicated by the play request;
evaluating whether a first subtitle display mode corresponding to the identification information exists; and
displaying subtitles of a target video on a video picture of the target video during a process of playing the target video, based on the first subtitle display mode determined to exist corresponding to the identification information.

2. The method of claim 1, further comprising:
showing, based on a detected trigger operation performing adjustment upon a subtitle display mode, a mode adjustment interface operative to adjust a subtitle display mode;
performing, based on a detected adjustment operation with regard to the mode adjustment interface, display adjustment upon the first subtitle display mode, and determining an adjusted first subtitle display mode; and
determining an adjusted first subtitle display mode as a first subtitle display mode corresponding to the identification information;
wherein display adjustment comprises at least one of display position adjustment, display typeface adjustment, display color adjustment, display size adjustment, arrangement adjustment, display background adjustment and display background transparency adjustment.

3. The method of claim 1, further comprising:
showing, upon detecting a trigger operation performing selection among subtitle display modes, multiple second subtitle display modes pending selection;
determining, based on a detected selection operation with regard to multiple second subtitle display modes, a selected second subtitle display mode; and
determining the selected second subtitle display mode as a first subtitle display mode corresponding to identification information.

4. The method of claim 1, further comprising:
showing, upon detecting a trigger operation creating a third subtitle display mode, a creation interface operative to perform subtitle display mode creation;
creating, based on a detected creation operation with regard to the creation interface, a third subtitle display mode; and
determining the third subtitle display mode as a first subtitle display mode corresponding to identification information.

5. The method of claim 4, wherein creating, based on a detected creation operation with regard to the creation interface, a third subtitle display mode comprises:
performing, upon detecting a first creation operation with regard to the creation interface, text typeface analysis upon detected input content, and determining a display typeface of subtitles of the third subtitle display mode based on analysis results; wherein input content comprises one of: text, and an image containing text.

6. The method of claim 4, wherein creating, based on a detected creation operation with regard to the creation interface, a third subtitle display mode comprises:
processing, upon detecting a second creation operation with regard to the creation interface, a detected input image, determining a display background of subtitles of the third subtitle display mode.

7. The method of claim 1, wherein first subtitle display modes corresponding to the identification information are multiple first subtitle display modes, and;
wherein displaying subtitles of a target video on a video picture of the target video during a process of playing the target video, based on a first subtitle display mode determined to exist corresponding to the identification information comprises:
showing multiple first subtitle display modes;
determining, based on detecting a selection operation with regard to the multiple first subtitle display modes, a selected first subtitle display mode; and
displaying, during a process of playing a target video, based on a selected first subtitle display mode, subtitles of the target video in a video picture of the target video.

8. The method of claim 1, further comprising:
determining, when a first subtitle display mode corresponding to the identification information does not exist, historical data of a subject identified by the identification information; and
determining, based on historical data, a first subtitle display mode corresponding to the identification information;
wherein the historical data comprises at least one of: historical behavior data of the subject, and user profile data of the subject.

9. The method of claim 1, wherein a subject identified by identification information comprises at least one of a terminal, a client terminal loaded by a terminal, and an account logged in through a terminal; and
identification information comprises at least one of an IP address of a terminal, an identifier of an account logged in through a terminal, an identifier of a client terminal loaded by a terminal, an identifier of an account logged in through a client terminal, and an identifier of a terminal.

10. The method of claim 1, wherein a first subtitle display mode comprises at least one of:
a display position of subtitles on the video picture, a display typeface of subtitles on the video picture, a display color of subtitles on the video picture, a display size of subtitles on the video picture, an arrangement of subtitles on the video picture, a display background of subtitles on the video picture, and a transparency of a display background of subtitles on the video picture.

11. An apparatus comprising:
one or more processors;
memory;
a request receiving module stored in the memory and configured to be executable by the one or more processors to determine, upon receiving a play request with regard to a target video, identification information indicated by the play request;
a display evaluating module stored in the memory and configured to be executable by the one or more processors to evaluate whether a first subtitle display mode corresponding to the identification information exists; and
a play controlling module stored in the memory and configured to be executable by the one or more processors to display subtitles of a target video on a video picture of the target video during a process of playing the target video, based on a first subtitle display mode determined to exist corresponding to the identification information.

12. The apparatus of claim 11, further comprising:
a mode adjustment interface showing module stored in the memory and configured to be executable by the one or more processors to show, based on a detected trigger operation performing adjustment upon a subtitle display mode, a mode adjustment interface operative to adjust a subtitle display mode;
a display adjustment module stored in the memory and configured to be executable by the one or more processors to, based on a detected adjustment operation with regard to the mode adjustment interface, display adjustment upon the first subtitle display mode, and determine an adjusted first subtitle display mode; and
a first mode adjusting module stored in the memory and configured to be executable by the one or more processors to determine an adjusted first subtitle display mode as a first subtitle display mode corresponding to the identification information;
wherein display adjustment comprises at least one of display position adjustment, display typeface adjustment, display color adjustment, display size adjustment, arrangement adjustment, display background adjustment and display background transparency adjustment.

13. The apparatus of claim 11, further comprising:
a mode showing module stored in the memory and configured to be executable by the one or more processors to show, upon detecting a trigger operation performing selection among subtitle display modes, multiple second subtitle display modes pending selection;
a mode selecting mode stored in the memory and configured to be executable by the one or more processors to determine, based on a detected selection operation with regard to multiple second subtitle display modes, a selected second subtitle display mode; and
a second mode determining module stored in the memory and configured to be executable by the one or more processors to determine the selected second subtitle display mode as a first subtitle display mode corresponding to identification information.

14. The apparatus of claim 11, further comprising:
a creation interface showing module stored in the memory and configured to be executable by the one or more processors to show, upon detecting a trigger operation creating a third subtitle display mode, a creation interface operative to perform subtitle display mode creation;
a mode creating module stored in the memory and configured to be executable by the one or more processors to create, based on a detected creation operation with regard to the creation interface, a third subtitle display mode; and
a third mode determining module stored in the memory and configured to be executable by the one or more processors to determine the third subtitle display mode as a first subtitle display mode corresponding to identification information.

15. The apparatus of claim 14, wherein the mode creating module further comprises:
a first creating submodule stored in the memory and configured to be executable by the one or more processors to perform, upon detecting a first creation operation with regard to the creation interface, text typeface analysis upon detected input content, and determine a display typeface of subtitles of the third subtitle display mode based on analysis results;
wherein input content comprises one of: text, and an image containing text.

16. The apparatus of claim 14, wherein the mode creating module further comprises:
a second creating submodule stored in the memory and configured to be executable by the one or more processors to process, upon detecting a second creation operation with regard to the creation interface, a detected input image, determining a display background of subtitles of the third subtitle display mode.

17. The apparatus of claim 11, wherein first subtitle display modes corresponding to the identification information are multiple first subtitle display modes, and
wherein the play controlling module comprises:
a showing submodule stored in the memory and configured to be executable by the one or more processors to show multiple first subtitle display modes;
a selection determining submodule stored in the memory and configured to be executable by the one or more processors to determine, based on detecting a selection operation with regard to the multiple first subtitle display modes, a selected first subtitle display mode; and
a play controlling submodule stored in the memory and configured to be executable by the one or more processors to display, during a process of playing a target video, based on a selected first subtitle display mode, subtitles of the target video in a video picture of the target video.

18. The apparatus of claim 11, further comprising:
a historical data determining module stored in the memory and configured to be executable by the one or more processors to determine, when a first subtitle display mode corresponding to the identification information does not exist, historical data of a subject identified by the identification information; and
a fourth mode determining module stored in the memory and configured to be executable by the one or more processors to determine, based on historical data, a first subtitle display mode corresponding to the identification information;
wherein the historical data comprises at least one of: historical behavior data of the subject, and user profile data of the subject.

19. The apparatus of claim 11, wherein a subject identified by identification information comprises at least one of: a terminal, a client terminal loaded by a terminal, and an account logged in through a terminal; and
identification information comprises at least one of: an IP address of a terminal, an identifier of an account logged in through a terminal, an identifier of a client terminal loaded by a terminal, an identifier of an account logged in through a client terminal, and an identifier of a terminal.

20. A computer-readable storage medium storing computer-readable instructions executable by one or more processors, that when executed by the one or more processors, cause the one or more processors to perform operations comprising:
determining, upon receiving a play request with regard to a target video, identification information indicated by the play request;
evaluating whether a first subtitle display mode corresponding to the identification information exists; and
displaying subtitles of a target video on a video picture of the target video during a process of playing the target video, based on a first subtitle display mode determined to exist corresponding to the identification information.
